(19) United States
(12) Patent Application Publication
(10) Pub. No.: US 2012/0105590 A1
(43) Pub. Date: May 3, 2012

(54) ELECTRONIC EQUIPMENT

(75) Inventors: Shinpei FUKUMOTO, Higashiosaka City (JP); Akihiko YAMADA, Daito City (JP); Kanichi KOYAMA, Higashiosaka City (JP); Yoshiyuki Tsuda, Hirakata City (JP)

(73) Assignee: SANYO ELECTRIC CO., LTD., Moriguchi City (JP)

(21) Appl. No.: 13/284,578

(22) Filed: Oct. 28, 2011

(30) Foreign Application Priority Data
Oct. 28, 2010 (JP) 2010-241969

(51) Int. Cl. H04N 13/02; H04N 13/04

(52) U.S. Cl. 348/46; 348/E13.074; 348/E13.075

(57) ABSTRACT

Electronic equipment includes a target output image generating portion that generates a target output image by changing a depth of field of a target input image by image processing, a monitor that displays on a display screen a distance histogram indicating a distribution of distance between an object at each position in the target input image and an apparatus that photographed the target input image, and displays on the display screen a selection index that is movable along a distance axis in the distance histogram, and a depth of field setting portion that sets a depth of field of the target output image based on a position of the selection index determined by an operation for moving the selection index along the distance axis.

### CROSS-REFERENCE TO RELATED APPLICATIONS

This nonprovisional application claims priority under 35 U.S.C. §119(a) on Patent Application No. 2010-241969 filed in Japan on Oct. 28, 2010, the entire contents of which are hereby incorporated by reference.

### BACKGROUND OF THE INVENTION

1. Field of the Invention

The present invention relates to electronic equipment such as an image pickup apparatus, a mobile information terminal, and a personal computer.

2. Description of Related Art

There is proposed a function of adjusting a focus state of a photographed image by image processing, and a type of processing for realizing this function is called a digital focus.

A depth of field of an output image obtained through the digital focus should satisfy user's desire. However, there is not yet a sufficient user interface for assisting a setting operation of the depth of field and confirmation thereof. If the assistance thereof is appropriately performed, a desired depth of field can be easily set.

### SUMMARY OF THE INVENTION

An electronic equipment according to a first aspect of the present invention includes a target output image generating portion that generates a target output image by changing a depth of field of a target input image by image processing, a monitor that displays on a display screen a distance histogram indicating a distribution of distance between an object at each position in the target input image and an apparatus that photographed the target input image, and displays on the display screen a selection index that is movable along a distance axis in the distance histogram, and a depth of field setting portion that sets a depth of field of the target output image based on a position of the selection index determined by an operation for moving the selection index along the distance axis.

An electronic equipment according to a second aspect of the present invention includes a target output image generating portion that generates a target output image by changing a depth of field of a target input image by image processing, a touch panel monitor having a display screen that accepts a touch panel operation when a touching object touches the display screen, and accepts a designation operation as the touch panel operation for designating a plurality of specific objects on the display screen in a state where the target input image or an image based on the target input image is displayed on the display screen, and a depth of field setting portion that sets a depth of field of the target output image based on the designation operation.

An electronic equipment according to a third aspect of the present invention includes a target output image generating portion that generates a target output image by changing a depth of field of a target input image by image processing, a touch panel monitor having a display screen that accepts a touch panel operation when a touching object touches the display screen, and accepts a designation operation as the touch panel operation for designating a specific object on the display screen in a state where the target input image or an image based on the target input image is displayed on the display screen, and a depth of field setting portion that sets a depth of field of the target output image so that the specific object is included in the depth of field of the target output image. The depth of field setting portion sets a width of the depth of field of the target output image in accordance with a time length while the touching object is touching the specific object on the display screen in the designation operation.

An electronic equipment according to a fourth aspect of the present invention includes a target output image generating portion that generates a target output image by changing a depth of field of a target input image by image processing, a depth of field setting portion that sets a depth of field of the target output image in accordance with a given operation, and a monitor that displays information indicating the set depth of field.

### BRIEF DESCRIPTION OF THE DRAWINGS

FIG. 1 is a schematic general block diagram of an image pickup apparatus according to an embodiment of the present invention.

FIG. 2 is an internal structural diagram of an imaging portion illustrated in FIG. 1.

FIG. 3 is a schematic exploded diagram of a monitor illustrated in FIG. 1.

FIG. 4A illustrates a relationship between an XY coordinate plane and a display screen, and FIG. 4B illustrates a relationship between the XY coordinate plane and a two-dimensional image.

FIG. 5 is a block diagram of a part related to a digital focus function according to the embodiment of the present invention.

FIG. 6A illustrates an example of a target input image to which the digital focus is applied, FIG. 6B illustrates a distance map of the target input image, and FIG. 6C illustrates a distance relationship between the image pickup apparatus and subjects.

FIG. 7 illustrates a relationship among a depth of field, a focus reference distance, a near point distance, and a far point distance.

FIGS. 8A to 8C are diagrams for explaining meanings of the depth of field, the focus reference distance, the near point distance, and the far point distance.

FIG. 9 is an action flowchart of individual portions illustrated in FIG. 5.

FIGS. 10A to 10E are structures of slider bars that can be displayed on the monitor illustrated in FIG. 1.

FIG. 11 is a diagram illustrating a manner in which the slider bar is displayed together with the target input image.

FIG. 12 is a diagram illustrating an example of a distance histogram.

FIGS. 13A and 13B are diagrams illustrating a combination of the distance histogram and the slider bar.

FIG. 14 is a diagram illustrating a combination of the distance histogram, the slider bar, and a typical distance object image.

FIG. 15 is a diagram illustrating individual subjects and display positions of the individual subjects on the display screen.

FIG. 16 is a diagram illustrating a manner in which an f-number is displayed on the display screen.

FIG. 17 is a diagram illustrating an example of a confirmation image that can be displayed on the display screen.

### DETAILED DESCRIPTION OF THE PREFERRED EMBODIMENTS

Hereinafter, examples of an embodiment of the present invention are described in detail with reference to the attached drawings. In the drawings to be referred, the same part is denoted by the same numeral or symbol, and overlapping description of the same part is omitted as a rule. Examples 1 to 6 will be described later. First, common matters to the examples or matters to be referred to in the examples are described.

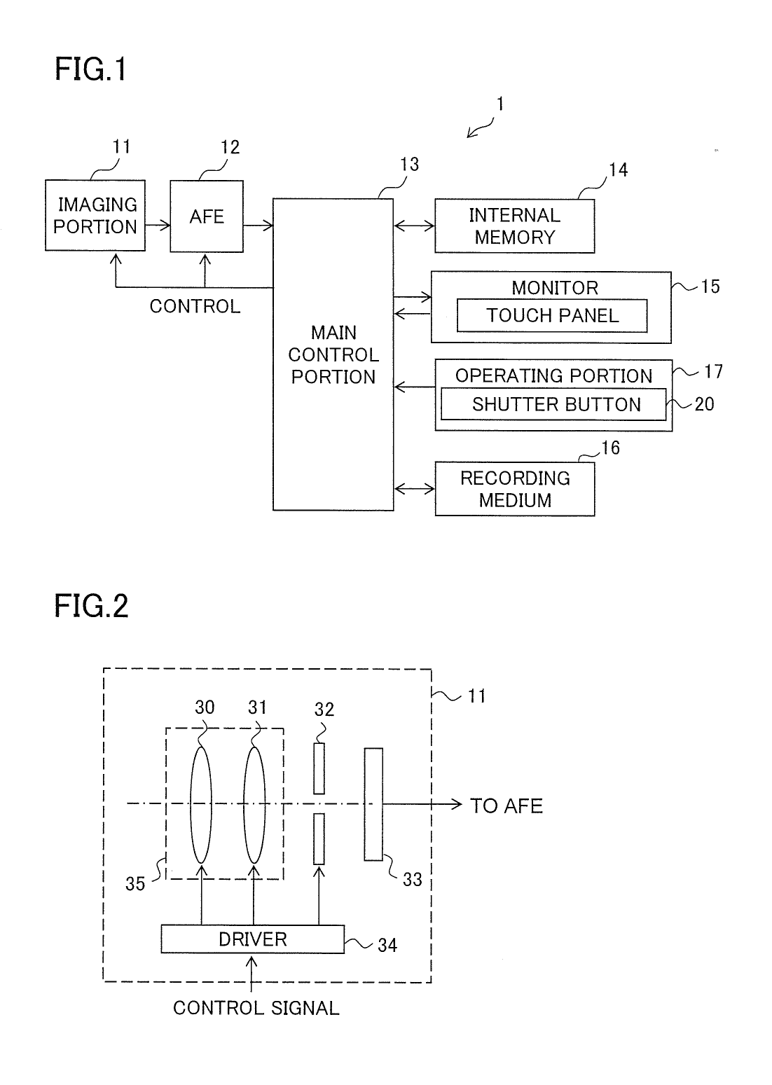

FIG. 1 is a schematic general block diagram of an image pickup apparatus 1 according to an embodiment of the present invention. The image pickup apparatus 1 is a digital still camera that can take and record still images, or a digital video camera that can take and record still images and moving images. The image pickup apparatus 1 may be incorporated in a mobile terminal such as a mobile phone.

The image pickup apparatus 1 includes an imaging portion 11, an analog front end (AFE) 12, a main control portion 13, an internal memory 14, a monitor 15, a recording medium 16, and an operating portion 17. Note that the monitor 15 may be also considered to be a monitor of a display apparatus disposed externally of the image pickup apparatus 1.

FIG. 2 illustrates an internal structural diagram of the imaging portion 11. The imaging portion 11 includes an optical system 35, an aperture stop 32, an image sensor 33 constituted of a charge coupled device (CCD) or a complementary metal oxide semiconductor (CMOS) image sensor, and a driver 34 for driving and controlling the optical system 35 and the aperture stop 32. The optical system 35 is constituted of a plurality of lenses including a zoom lens 30 and a focus lens 31. The zoom lens 30 and the focus lens 31 can move in an optical axis direction. The driver 34 drives and controls positions of the zoom lens 30 and the focus lens 31, and an opening ratio of the aperture stop 32, based on a control signal from the main control portion 13, so as to control a focal length (angle of view) and a focal position of the imaging portion 11, and incident light intensity to the image sensor 33.

The image sensor 33 performs photoelectric conversion of an optical image of a subject entering via the optical system 35 and the aperture stop 32, and outputs an electric signal obtained by the photoelectric conversion to the AFE 12. More specifically, the image sensor 33 includes a plurality of light receiving pixels arranged like a matrix in a two-dimensional manner. In each photograph, each of the light receiving pixels stores signal charge having charge quantity corresponding to exposure time. An analog signal from each light receiving pixel having amplitude proportional to the charge quantity of the stored signal charge is output to the AFE 12 sequentially in accordance with a driving pulse generated in the image pickup apparatus 1.

The AFE 12 amplifies the analog signal output from the imaging portion 11 (image sensor 33) and converts the amplified analog signal into a digital signal. The AFE 12 output this digital signal as RAW data to the main control portion 13. An amplification degree of signal amplification in the AFE 12 is controlled by the main control portion 13.

The main control portion 13 is constituted of a central processing unit (CPU), a read only memory (ROM), a random access memory (RAM), and the like. The main control portion 13 generates image data indicating the image photographed by the imaging portion 11 (hereinafter, referred to also as a photographed image), based on the RAW data from the AFE 12. The image data generated here contains, for example, a luminance signal and a color difference signal. However, the RAW data itself is one type of the image data, and the analog signal output from the imaging portion 11 is also one type of the image data. In addition, the main control portion 13 also has a function as a display control portion that controls display content of the monitor 15 and performs control of the monitor 15 that is necessary for display.

The internal memory 14 is constituted of a synchronous dynamic random access memory (SDRAM) or the like and temporarily stores various data generated in the image pickup apparatus 1. The monitor 15 is a display apparatus having a display screen of a liquid crystal display panel or the like and displays a photographed image, an image recorded in the recording medium 16 or the like, under control of the main control portion 13.

The recording medium 16 is a nonvolatile memory such as a card-like semiconductor memory or a magnetic disk and stores photographed images and the like under control of the main control portion 13. The operating portion 17 includes a shutter button 20 and the like for accepting an instruction to photograph a still image, and accepts various external operations. An operation to the operating portion 17 is also referred to as a button operation so as to distinguish from the touch panel operation. The operation content to the operating portion 17 is sent to the main control portion 13.

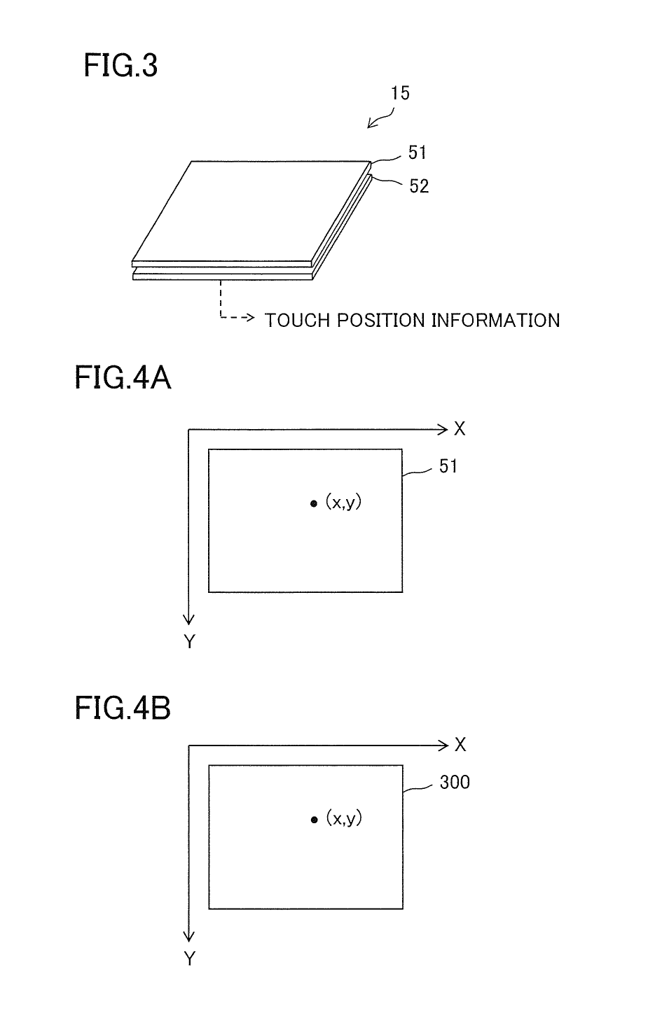

The monitor 15 is equipped with the touch panel. FIG. 3 is a schematic exploded diagram of the monitor 15. The monitor 15 as a touch panel monitor includes a display screen 51 constituted of a liquid crystal display or the like, and a touch detecting portion 52 that detects a position of the display screen 51 touched by the touching object (pressed position). The user touches the display screen 51 of the monitor 15 by the touching object and hence can issue a specific instruction to the image pickup apparatus 1. The operation of touching the display screen 51 by the touching object is referred to as a touch panel operation. A contact position between the touching object and the display screen 51 is referred to as a touch position. When the touching object touches the display screen 51, the touch detecting portion 52 outputs touch position information indicating the touched position (namely, the touch position) to the main control portion 13 in real time. The touching object means a finger, a pen or the like. Hereinafter, it is supposed that the touching object is mainly a finger. In addition, when simply referred to as a display in this specification, it is supposed to mean a display on the display screen 51.

As illustrated in FIG. 4A, a position on the display screen 51 is defined as a position on a two-dimensional XY coordinate plane. In addition, as illustrated in FIG. 4B, in the image pickup apparatus 1, an arbitrary two-dimensional image 300 is also handled as an image on the XY coordinate plane. The XY coordinate plane includes an X-axis extending in the horizontal direction of the display screen 51 and the two-dimensional image 300 and a Y-axis extending in the vertical direction of the display screen 51 and the two-dimensional image 300, as coordinate axes. All images described in this specification are two-dimensional images unless otherwise noted. A position of a noted point on the display screen 51 and the two-dimensional image 300 is expressed by (x, y). A letter x represents an X-axis coordinate value of the noted point and represents a horizontal position of the noted point on the display screen 51 and the two-dimensional image 300. A letter y represents a Y-axis coordinate value of the noted point and represents a vertical position of the noted point on the display screen 51 and the two-dimensional image 300. When the two-dimensional image 300 is displayed on the display screen 51 (when the two-dimensional image 300 is display using the entire display screen 51), an image at a position (x, y) on the two-dimensional image 300 is displayed at a position (x, y) on the display screen 51.

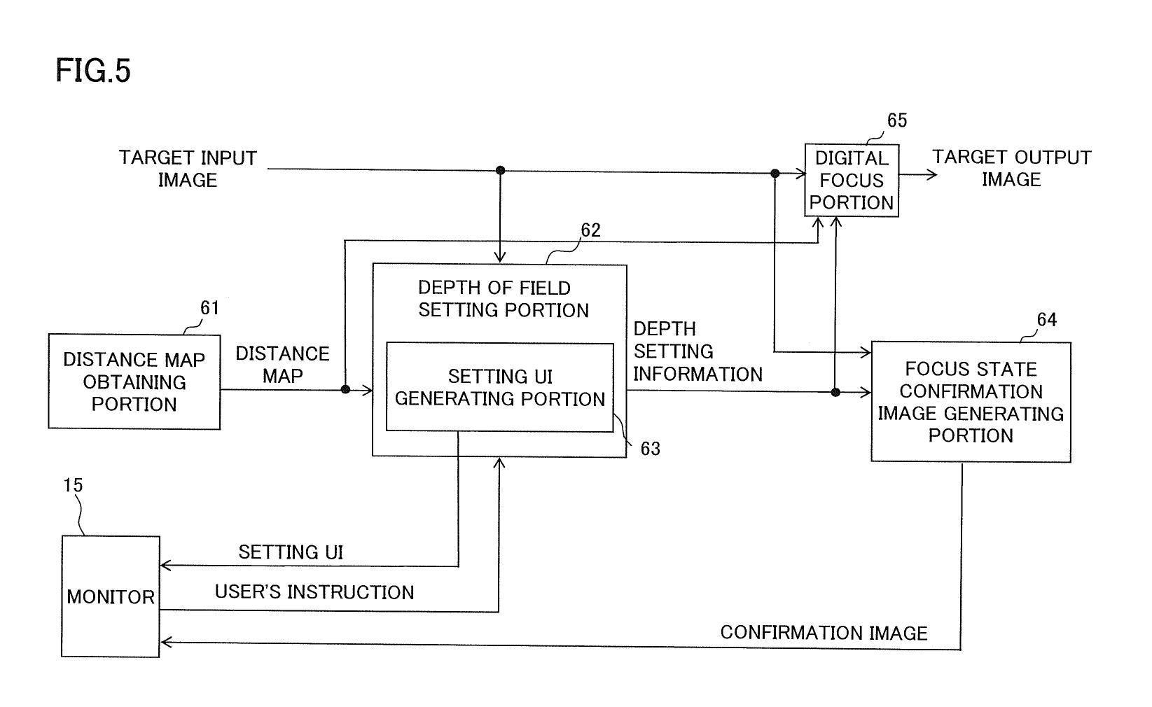

The image pickup apparatus 1 has a function of changing a depth of field of the photographed image after obtaining image data of the photographed image. Here, this function is referred to as digital focus function. FIG. 5 illustrates a block diagram of portions related to the digital focus function. The portions denoted by numerals 61 to 65 can be disposed in the main control portion 13 of FIG. 1, for example.

The photographed image before changing the depth of field is referred to as a target input image and the photographed image after changing the depth of field is referred to as a target output image. The target input image is a photographed image based on RAW data, and an image obtained by performing a predetermined image processing (for example, a demosaicing process or a noise reduction process) on the RAW data may be the target input image. In addition, it is possible to temporarily store image data of the target input image in the recording medium 16 and afterward to read the image data of the target input image from the recording medium 16 at an arbitrary timing so as to impart the image data of the target input image to the individual portions illustrated in FIG. 5.

[Distance Map Obtaining Portion]

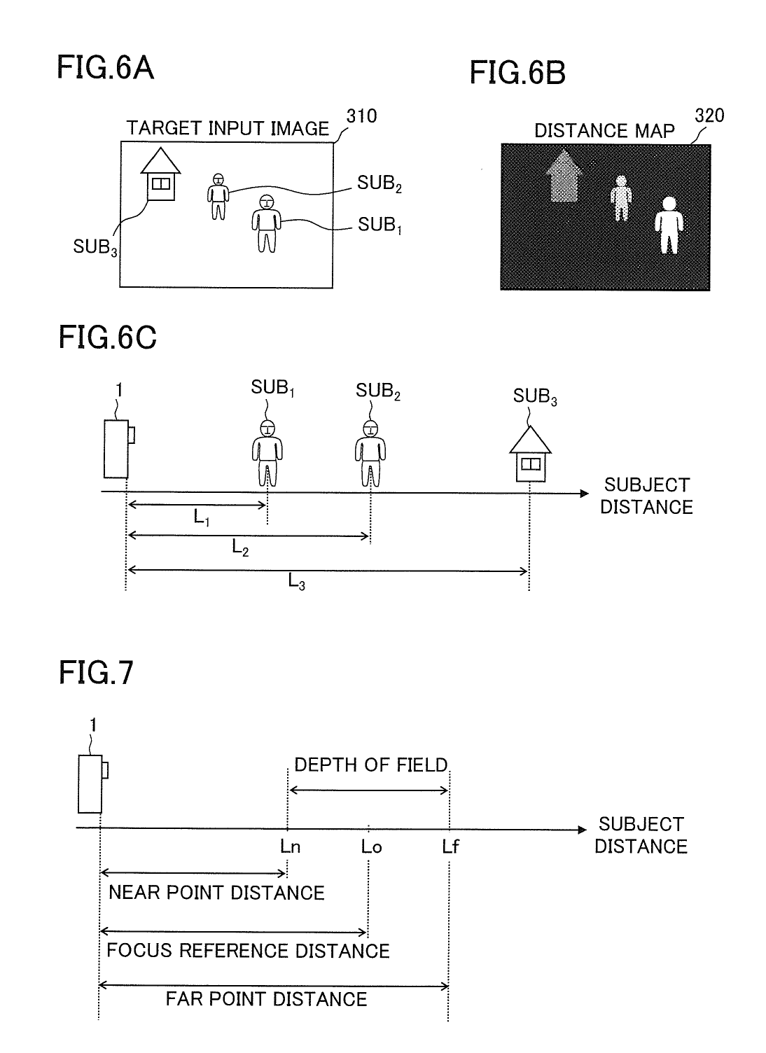

The distance map obtaining portion 61 performs a subject distance detecting process of detecting subject distances of individual subjects within a photographing range of the image pickup apparatus 1, and thus generates a distance map (subject distance information) indicating subject distances of subjects at individual positions on the target input image. The subject distance of a certain subject means a distance between the subject and the image pickup apparatus 1 (more specifically, the image sensor 33) in real space. The subject distance detecting process can be performed periodically or at desired timing. The distance map can be said to be a range image in which individual pixels constituting the image have detected values of the subject distance. An image 310 of FIG. 6A is an example of the target input image, and a range image 320 of FIG. 6B is a distance map based on the target input image 310. In the diagram illustrating the range image, a part having a smaller subject distance is expressed in brighter white, and a part having a larger subject distance is expressed in darker black. The target input image 310 is obtained by photographing a subject group including subjects SUB₁ to SUB₃. As illustrated in FIG. 6C, the subject distances of the subjects SUB₁ to SUB₃ are denoted by L₁ to L₃, respectively. Here, 0<L₁<L₂<L₃ is satisfied.

It is possible to adopt a structure in which the subject distance detecting process is performed when the target input image is photographed, and the distance map obtained by the process is associated with the image data of the target input image and is recorded in the recording medium 16 together with the image data of the target input image. By this method, the distance map obtaining portion 61 can obtain the distance map from the recording medium 16 at an arbitrary timing. Note that the above-mentioned association is realized by storing the distance map in the header region of the image file storing the image data of the target input image, for example.

As a detection method of the subject distance and a generation method of the distance map, an arbitrary method including a known method can be used. The image data of the target input image may be used for generating the distance map, or information other than the image data of the target input image may be used for generating the distance map. For instance, the distance map may be generated by a stereo method (stereo vision method) from images photographed using two imaging portions. One of two imaging portions can be the imaging portion 11. Alternatively, for example, the distance map may be generated by using a distance sensor (not shown) for measuring subject distances of individual subjects. It is possible to use a distance sensor based on a triangulation method or an active type distance sensor as the distance sensor. The active type distance sensor includes a light emitting element and measures a period of time after light is emitted from the light emitting element toward a subject within the photographing range of the image pickup apparatus 1 until the light is reflected by the subject and comes back, so that the subject distance of each subject can be detected based on the measurement result.

Alternatively, for example, the imaging portion 11 may be constituted so that the RAW data contains information of the subject distances, and the distance map may be generated from the RAW data. In order to realize this, it is possible to use, for example, a method called “Light Field Photography” (for example, a method described in WO 06/039486 or JP-A-2009-224982; hereinafter, referred to as Light Field method). In the Light Field method, an imaging lens having an aperture stop and a micro-lens array are used so that the image signal obtained from the image sensor contains information in a light propagation direction in addition to light intensity distribution in a light receiving surface of the image sensor. Therefore, though not illustrated in FIG. 2, optical members necessary for realizing the Light Field method are disposed in the imaging portion 11 when the Light Field method is used. The optical members include the micro-lens array and the like, and incident light from the subject enters the light receiving surface (namely, an imaging surface) of the image sensor 33 via the micro-lens array and the like. The micro-lens array is constituted of a plurality of micro-lenses, and one micro-lens is assigned to one or more light receiving pixels of the image sensor 33. Thus, an output signal of the image sensor 33 contains information of the incident light propagation direction to the image sensor 33 in addition to the light intensity distribution in the light receiving surface of the image sensor 33.

Still alternatively, for example, it is possible to generate the distance map from the image data of the target input image (RAW data) using axial color aberration of the optical system 35 as described in JP-A-2010-81002.

[Depth of Field Setting Portion]

The depth of field setting portion 62 illustrated in FIG. 5 is supplied with the distance map and the image data of the target input image, and has a setting UI generating portion 63. However, the setting UI generating portion 63 may be considered to be disposed externally of the depth of field setting portion 62. The setting UI generating portion 63 generates a setting UI (user interface) and displays the setting UI together with an arbitrary image on the display screen 51. The depth of field setting portion 62 generates depth setting information based on a user's instruction. The user's instruction affecting the depth setting information is realized by a touch panel operation or a button operation. The button operation includes an operation to an arbitrary operating member (a button, a cross key, a dial, a lever, or the like) disposed in the operating portion 17.

The depth setting information contains information designating the depth of field of the target output image, and a focus reference distance, a near point distance, and a far point distance included in the depth of field of the target output image are designated by the information. A difference between the near point distance of the depth of field and the far point distance of the depth of field is referred to as a width of the depth of field. Therefore, the width of the depth of field in the target output image is also designated by the depth setting information. As illustrated in FIG. 7, the focus reference distance of an arbitrary noted image is denoted by symbol Lo. Further, the near point distance and the far point distance of the depth of field of the noted image is denoted by symbols Ln and Lf, respectively. The noted image is, for example, a target input image or a target output image.

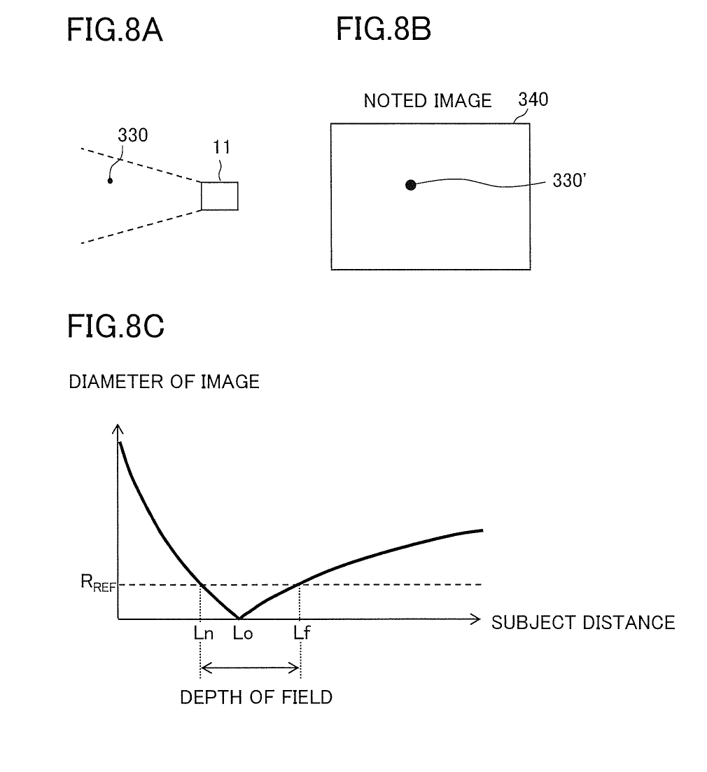

With reference to FIGS. 8A to 8C, meanings of the depth of field, the focus reference distance Lo, the near point distance Ln, and the far point distance Lf are described. As illustrated in FIG. 8A, it is supposed that the photographing range of the imaging portion 11 includes an ideal point light source 330 as a subject. In the imaging portion 11, incident light from the point light source 330 forms an image at an imaging point via the optical system 35. When the imaging point is on the imaging surface of the image sensor 33, the diameter of the image of the point light source 330 on the imaging surface is substantially zero and is smaller than a permissible circle of confusion of the image sensor 33. On the other hand, if the imaging point is not on the imaging surface of the image sensor 33, the optical image of the point light source 330 on the imaging surface is burred. As a result, a diameter of the image of the point light source 330 on the imaging surface can be larger than the permissible circle of confusion. If the diameter of the image of the point light source 330 on the imaging surface is smaller than or equal to the permissible circle of confusion, the subject as the point light source 330 is in focus on the imaging surface. If the diameter of the image of the point light source 330 on the imaging surface is larger than the permissible circle of confusion, the subject as the point light source 330 is not in focus on the imaging surface.

Considering in the same manner, as illustrated in FIG. 8B, it is supposed that a noted image 340 includes an image 330′ of the point light source 330 as a subject image. In this case, if the diameter of the image 330′ is smaller than or equal to a reference diameter R_{REF} corresponding to the pennissible circle of confusion, the subject as the point light source 330 is in focus in the noted image 340. If the diameter of the image 330′ is larger than the reference diameter R_{REF}, the subject as the point light source 330 is not in focus in the noted image 340. A subject that is in focus in the noted image 340 is referred to as a focused subject, and a subject that is not in focus in the noted image 340 is referred to as a non-focused subject. If a certain subject is within the depth of field of the noted image 340 (namely, if a subject distance of a certain subject belongs to the depth of field of the noted image 340), the subject is a focused subject in the noted image 340. If a certain subject is not within the depth of field of the noted image 340 (namely, if a subject distance of a certain subject does not belong to the depth of field of the noted image 340), the subject is a non-focused subject in the noted image 340.

As illustrated in FIG. 8C, a range of the subject distance in which the diameter of the image 330′ is the reference diameter R_{REF} or smaller is the depth of field of the noted image 340. The focus reference distance Lo, the near point distance Ln, and the far point distance Lf of the noted image 340 belong to the depth of field of the noted image 340. The subject distance that gives a minimum value to the diameter of the image 330′ is the focus reference distance Lo of the noted image 340. A minimum distance and a maximum distance in the depth of field of the noted image 340 are the near point distance Ln and the far point distance Lf, respectively.

[Focus State Confirmation Image Generating Portion]

A focus state confirmation image generating portion 64 (hereinafter, may be referred to as a confirmation image generating portion 64 or a generating portion 64 shortly) illustrated in FIG. 5 generates a confirmation image for informing the user of the focus state of the target output image generated by the depth setting information. The generating portion 64 can generate the confirmation image based on the depth setting information and the image data of the target input image. The generating portion 64 can use the distance map and the image data of the target output image for generating the confirmation image as necessary. The confirmation image is displayed on the display screen 51, and hence the user can recognize the focus state of the already generated target output image or the focus state of a target output image that is scheduled to be generated.

[Digital Focus Portion]

A digital focus portion (target output image generating portion) 65 illustrated in FIG. 5 can realize image processing for changing the depth of field of the target input image. This image processing is referred to as digital focus. By the digital focus, it is possible to generate the target output image having an arbitrary depth of field from the target input image. The digital focus portion 65 can generate the target output image so that the depth of field of the target output image is agreed with the depth of field defined in the depth setting information, by the digital focus based on the image data of the target input image, the distance map, and the depth setting information. The generated target output image can be displayed on the monitor 15, and the image data of the target output image can be recorded in the recording medium 16.

The target input image is an ideal or pseudo pan-focus image. The pan-focus image means an image in which all subjects having image data in the pan-focus image are in focus. If all subjects in the noted image are the focused subjects, the noted image is the pan-focus image. Specifically, for example, using so-called pan-focus (deep focus) in the imaging portion 11 for photographing the target input image, the target input image can be the ideal or pseudo pan-focus image. In other words, when the target input image is photographed, the depth of field of the imaging portion 11 should be sufficiently deep so as to photograph the target input image. If all subjects included in the photographing range of the imaging portion 11 are within the depth of field of the imaging portion 11 when the target input image is photographed, the target input image works as the ideal pan-focus image. In the following description, it is supposed that all subjects included in the photographing range of the imaging portion 11 are within the depth of field of the imaging portion 11 when the target input image is photographed, unless otherwise noted.

In addition, when simply referred to as a depth of field, a focus reference distance, a near point distance, or a far point distance in the following description, they are supposed to indicate a depth of field, a focus reference distance, a near point distance, or a far point distance of the target output image, respectively. In addition, it is supposed that the near point distance and the far point distance corresponding to inner and outer boundary distances of the depth of field are distances within the depth of field (namely, they belong to the depth of field).

The digital focus portion 65 extracts the subject distances corresponding to the individual pixels of the target input image from the distance map. Then, based on the depth setting information, digital focus portion 65 classifies the individual pixels of the target input image into blurring target pixels corresponding to subject distances outside the depth of field of the target output image and non-blurring target pixels corresponding to subject distances within the depth of field of the target output image. An image region including all the blurring target pixels is referred to as a blurring target region, and an image region including all the non-blurring target pixels is referred to as a non-blurring target region. In this way, the digital focus portion 65 can classify the entire image region of the target input image into the blurring target region and the non-blurring target region based on the distance map and the depth setting information. For instance, in the target input image 310 of FIG. 6A, the image region where the image data of the subject SUB₁ exists is classified to the blurring target region if the subject distance L₁ is positioned outside the depth of field of the target output image, and is classified to the non-blurring target region if the subject distance L₁ is positioned within the depth of field of the target output image (see FIG. 6C). The digital focus portion 65 performs blurring processing only on the blurring target region of the target input image, and can generate the target input image after this blurring processing as the target output image.

The blurring processing is a process of blurring images in an image region on which the blurring processing is performed (namely, the blurring target region). The blurring processing can be realized by two-dimensional spatial domain filtering. The filter used for the spatial domain filtering of the blurring processing is an arbitrary spatial domain filter suitable for smoothing of an image (for example, an averaging filter, a weighted averaging filter, or a Gaussian filter).

Specifically, for example, the digital focus portion 65 extracts a subject distance L_{BLUR} corresponding to the blurring target pixel from the distance map for each blurring target pixel, and sets a blurring amount based on the extracted subject distance L_{BLUR} and the depth setting information for each blurring target pixel. Concerning a certain blurring target pixel, if the extracted subject distance L_{BLUR} is smaller than the near point distance Ln, the blurring amount is set so that the blurring amount for the blurring target pixel is larger as a distance difference (Ln-L_{BLUR}) is larger. In addition, if the extracted subject distance L_{BLUR} is larger than the far point distance Lf, the blurring amount is set so that the blurring amount for the blurring target pixel is larger as a distance difference (L_{BLUR}-Lf) is larger. Then, for each blurring target pixel, the pixel signal of the blurring target pixel is smoothed by using the spatial domain filter corresponding to the blurring amount. Thus, the blurring processing can be realized.

In this case, as the blurring amount is larger, a filter size of the spatial domain filter to be used may be larger. Thus, as the blurring amount is larger, the corresponding pixel signal is blurred more. As a result, a subject that is not within the depth of field of the target output image is blurred more as the subject is farther from the depth of field.

Note that the blurring processing can be realized also by frequency filtering. The blurring processing may be a low pass filtering process for reducing relatively high spatial frequency components among spatial frequency components of the images within the blurring target region.

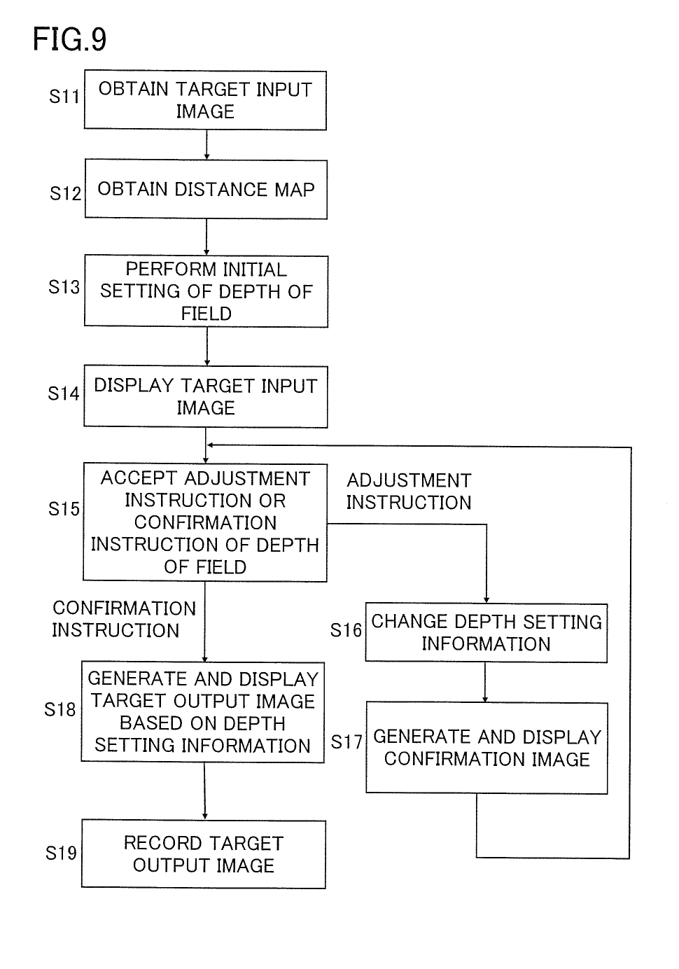

FIG. 9 is a flowchart indicating a flow of generating action of the target output image. First, in Steps S11 and S12, the image data of the target input image is obtained by photographing, and the distance map is obtained by the above-mentioned method. In Step S13, initial setting of the depth of field is performed. In this initial setting, the blurring amount for every subject distance is set to zero. Setting of the blurring amount of every subject distance to zero corresponds to setting the entire image region of the target input image to the non-blurring target region.

In the next Step S14, the target input image is displayed on the display screen 51. It is possible to display an arbitrary index together with the target input image. This index is, for example, a file name, photographed date, and the setting UI generated by the setting UI generating portion 63 (a specific example of the setting UI will be described later). In Step S14, it is possible to display not the target input image itself but an image based on the target input image. Here, the image based on the target input image includes an image obtained by performing a resolution conversion on the target input image or an image obtained by performing a specific image processing on the target input image.

Next in Step S15, the image pickup apparatus 1 accepts a user's adjustment instruction (change instruction) instructing to change the depth of field or a confirmation instruction instructing to complete the adjustment of the depth of field. Each of the adjustment instruction and the confirmation instruction is performed by a predetermined touch panel operation or button operation. If the adjustment instruction is performed, the process flow goes to Step S16 from Step S15. If the confirmation instruction is performed, the process flow goes to Step S18 from Step S15.

In Step S16, the depth of field setting portion 62 changes the depth setting information in accordance with the adjustment instruction. In the next Step S17, the confirmation image generating portion 64 generates the confirmation image that is an image based on the target input image using the changed depth setting information (a specific example of the confirmation image will be described later in Example 4 and the like). The confirmation image generated in Step S17 is displayed on the display screen 51 and the process flow goes back to Step S15 with this display sustained. In other words, in the state where the confirmation image is displayed, the adjustment operation in Step S15 is received again. In this case, when the confirmation instruction is issued, the process of Steps S18 and S19 is performed. When the adjustment instruction is performed again, the process of Steps S16 and S17 is performed again in accordance with the repeated adjustment instruction. Note that it is possible to display the setting UI generated by the setting UI generating portion 63 together with the confirmation image on the display screen 51.

In Step S18, the digital focus portion 65 generates the target output image from the target input image by the digital focus based on the depth setting information. The generated target output image is displayed on the display screen 51. If the adjustment instruction is never issued in Step S15, the target input image itself can be generated as the target output image. If the adjustment instruction is issued in Step S15, the target output image is generated based on the depth setting information that is changed in accordance with the adjustment instruction. After that, in Step S19, the image data of the target output image is recorded in the recording medium 16. If the image data of the target input image is recorded in the recording medium 16, the image data of the target input image may be erased from the recording medium 16 when recording the image data of the target output image. Alternatively, the record of the image data of the target input image may be maintained.

Note that it is possible to generate the target output image without waiting an input of the confirmation instruction after receiving the adjustment instruction. Similarly to this, after changing the depth setting information in Step S16, instead of generating and displaying the confirmation image, it is possible to generate and display the target output image based on the changed depth setting information without delay and to receive the adjustment operation in Step S15 again in the state where the target output image is displayed.

Hereinafter, Examples 1 to 6 are described as specific examples for realizing the digital focus and the like. As long as no contradiction arises, description in one example and description in another example can be combined. Unless otherwise noted, it is supposed that the target input image 310 of FIG. 6A is imparted to the individual portions illustrated in FIG. 5 in Examples 1 to 6, and that the distance map means a distance map of the target input image 310.

### Example 1

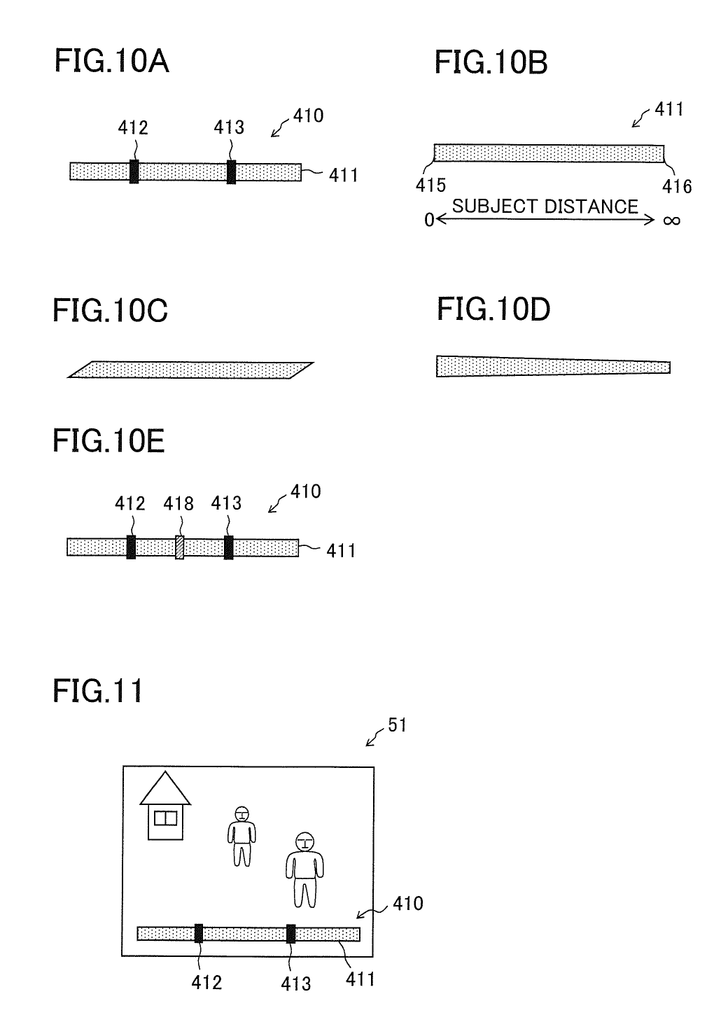

Example 1 of the present invention is described. FIG. 10A illustrates a slider bar 410 as the setting UI. The slider bar 410 is constituted of a rectangular distance axis icon 411 extending in a certain direction on the display screen 51 and a bar icons (selection indices) 412 and 413 that can move along the distance axis icon 411 in the certain direction. A position on the distance axis icon 411 indicates the subject distance. As illustrated in FIG. 10B, one end 415 of the distance axis icon 411 in the longitudinal direction corresponds to zero subject distance and the other end 416 corresponds to infinity subject distance or sufficiently large subject distance. The positions of the bar icons 412 and 413 on the distance axis icon 411 correspond to the near point distance Ln and the far point distance Lf, respectively. Therefore, the bar icon 412 is always nearer to the end 415 than the bar icon 413. Note that a shape of the distance axis icon 411 may be other than the rectangular shape, including, for example, a parallelogram or a trapezoid as illustrated in FIG. 10C or 10D.

When the slider bar 410 is displayed, the user can move the bar icons 412 and 413 on the distance axis icon 411 by the touch panel operation or the button operation. For instance, after touching the bar icon 412 by finger, while maintaining the contact state between the finger and the display screen 51, the user can move the finger on the display screen 51 along the extending direction of the distance axis icon 411 so that the bar icon 412 can move on the distance axis icon 411. The same is true for the bar icon 413. In addition, if a cross-shaped key (not shown) constituted of first to fourth direction keys is disposed in the operating portion 17, it is possible, for example, to move the bar icon 412 toward the end 415 by pressing the first direction key, or to move the bar icon 412 toward the end 416 by pressing the second direction key, or to move the bar icon 413 toward the end 415 by pressing the third direction key, or to move the bar icon 413 toward the end 416 by pressing the fourth direction key. In addition, for example, if a dial button is disposed in the operating portion 17, it is possible to move the bar icons 412 and 413 by dial operation of the dial button.

As illustrated in FIG. 11, the image pickup apparatus 1 also displays the slider bar 410 when the target input image 310 or an image based on the target input image 310 is displayed. In this state, the image pickup apparatus 1 accepts user's adjustment instruction or confirmation instruction of the depth of field (see FIG. 9). The user's touch panel operation or button operation for changing the positions of the bar icons 412 and 413 corresponds to the adjustment instruction. On the distance axis icon 411, difference positions correspond to different subject distances. When a position of the bar icon 412 is changed by the adjustment instruction, the depth of field setting portion 62 changes the near point distance Ln in accordance with the changed position of the bar icon 412. When a position of the bar icon 413 is changed by the adjustment instruction, the depth of field setting portion 62 changes the far point distance Lf in accordance with the changed position of the bar icon 413. In addition, the depth of field setting portion 62 can set the focus reference distance Lo based on the near point distance Ln and the far point distance Lf (a method of deriving the distance Lo will be described later). The distances Ln, Lf, and Lo changed or set by the adjustment instruction are reflected on the depth setting information (Step S16 of FIG. 9).

Note that the longitudinal direction of the slider bar 410 is the horizontal direction of the display screen 51 in FIG. 11, but the longitudinal direction of the slider bar 410 may be any direction on the display screen 51. In addition, in Steps S15 to S17 of FIG. 9, a bar icon 418 indicating the focus reference distance Lo may be displayed on the distance axis icon 411 together with the bar icons 412 and 413 as illustrated in FIG. 10E.

When confirming that the bar icons 412 and 413 are at desired positions, the user can issue the above-mentioned confirmation instruction. When the confirmation instruction is issued, the target output image is generated based on the depth setting information at time point when the confirmation instruction is issued (Step S18 of FIG. 9).

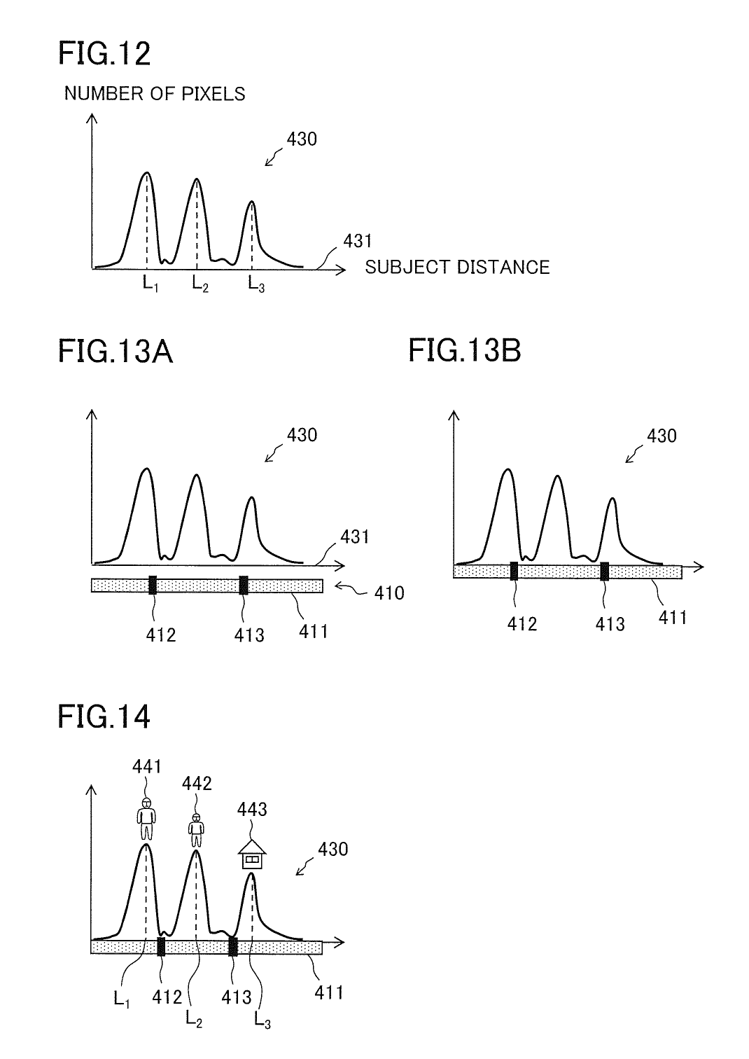

In addition, a histogram obtained by using the subject distances at pixel positions of the target input image as variable is referred to as a distance histogram. FIG. 12 illustrates a distance histogram 430 corresponding to the target input image 310. The distance histogram 430 expresses distribution of subject distances of pixel positions of the target input image 310. The image pickup apparatus 1 (for example, the depth of field setting portion 62 or the setting UI generating portion 63) can generate the distance histogram 430 based on the distance map of the target input distance 310. In the distance histogram 430, the horizontal axis represents a distance axis 431 indicating the subject distance. The vertical axis of the distance histogram 430 represents a frequency of the distance histogram 430. For instance, if there are Q pixels having a pixel value of the subject distance L₁ in the distance map, a frequency (the number of pixels) for the subject distance L₁ in the distance histogram 430 is Q (Q denotes an integer).

The distance histogram 430 may be included in the setting UI. When the slider bar 410 of FIG. 10A is displayed, it is preferred to display the distance histogram 430, too. In this case, as illustrated in FIG. 13A, it is preferred to associate the distance axis icon 411 of the slider bar 410 with the distance axis 431 of the distance histogram 430 so that the bar icons 412 and 413 can move along the distance axis 431. For instance, the longitudinal direction of the distance axis icon 411 and the direction of the distance axis 431 are agreed with the horizontal direction of the display screen 51. In addition, a subject distance on the distance axis icon 411 corresponding to an arbitrary horizontal position Hp on the display screen 51 is agreed with a subject distance on the distance axis 431 corresponding to the same horizontal position Hp. According to this, the movement of the bar icons 412 and 413 on the distance axis icon 411 becomes a movement along the distance axis 431. In the example illustrated in FIG. 13A, the distance histogram 430 and the slider bar 410 are displayed in side by side in the vertical direction, but the slider bar 410 may be incorporated in the distance histogram 430. In other words, for example, the distance axis icon 411 may be displayed as the distance axis 431 as illustrated in FIG. 13B.

When the target input image 310 or an image based on the target input image 310 is displayed, the image pickup apparatus 1 may also display the setting UI including the distance histogram 430 and the slider bar 410. In this state, the image pickup apparatus 1 can accept the user's adjustment instruction or confirmation instruction of the depth of field (see FIG. 9). The adjustment instruction in this case is the touch panel operation or the button operation for changing the positions of the bar icons 412 and 413 in the same manner as the case where only the slider bar 410 is included in the setting UI. The actions including the setting action of the distances Ln, Lf, and Lo accompanying the change of the positions of the bar icons 412 and 413 are the same as described above. The user confirms that the bar icons 412 and 413 are at desired positions and can perform the above-mentioned confirmation instruction. When the confirmation instruction is performed, the target output image is generated based on the depth setting information at time point when the confirmation instruction is performed (Step S18 of FIG. 9).

Using the slider bar as described above, it is possible to set the depth of field by a visceral and simple operation. In this case, by displaying the distance histogram together, the user can set the depth of field while grasping distribution of the subject distance. For instance, it is possible to facilitate the adjustment such as including a typical subject distance that is positioned close to the image pickup apparatus 1 and has high frequency (for example, the subject distance L₁ corresponding to the subject SUB₁) in the depth of field, or excluding a substantially large subject distance having high frequency (for example, the subject distance L₃ corresponding to the subject SUB₃ like a background) from the depth of field. Thus, the user can easily set the desired depth of field.

When the touch panel operation or the button operation is performed to move the bar icons 412 and 413 on the distance axis icon 411 or on the distance axis 431 of the distance histogram 430, positions of the slide bars 412 and 413 may be continuously moved. However, it is possible to change positions of the slide bars 412 and 413 step by step on the distance axis icon 411 or on the distance axis 431 from a typical distance existing discretely to another typical distance. Thus, when instructing to move the bar icons 412 and 413 by the button operation, in particular, it is possible to set the depth of field more easily and promptly. For instance, it is supposed that only the subject distances L₁ to L₃ are set to the typical distances with respect to the distance histogram 430. In this case, first to third typical positions corresponding to first to third typical distances L₁ to L₃ are set on the distance axis icon 411 or on the distance axis 431. Further, when the bar icon 412 is positioned at the second typical position, if the user performs the operation for moving the bar icon 412 by one unit amount, a position of the bar icon 412 moves to the first or the third typical position (the same is true for the bar icon 413).

The setting UI generating portion 63 can set the typical distances from the frequencies of the subject distances in the distance histogram 430. For instance, in the distance histogram 430, the subject distance at which the frequencies are concentrated can be set as the typical distance. More specifically, for example, in the distance histogram 430, the subject distance having a frequency of a predetermined threshold value or higher can be set as the typical distance. In the distance histogram 430, if subject distances having a frequency of a predetermined threshold value or higher exist continuously in a certain distance range, a center distance of the certain distance range can be set as the typical distance. It is possible to adopt a structure in which a window having a certain distance range is set on the distance histogram 430, and if a sum of frequencies within the window is a predetermined threshold value or higher, a center distance of the window is set as the typical distance.

In addition, it is possible to adopt a structure as below. The depth of field setting portion 62 (for example, the setting UI generating portion 63) extracts image data of a subject having a typical distance as the subject distance from image data of the target input image 310. When the adjustment instruction or the confirmation instruction is accepted, the image based on the extracted image data (hereinafter referred to as a typical distance object image) is displayed in association with the typical distance on the distance histogram 430. The typical distance object image may also be considered to be included in the setting UI.

Supposing that the subject distances L₁ to L₃ are set to the first to third typical distances, a method of generating and displaying the typical distance object image is described. The setting UI generating portion 63 detects an image region having the typical distance L₁ or a distance close to the typical distance L₁ as the subject distance based on the distance map, and extracts image data in the detected image region from the target input image 310 as image data of a first typical distance object image. The distance close to the typical distance L₁ means, for example, a distance having a distance difference with the typical distance L₁ that is a predetermined value or smaller. In the same manner, the setting UI generating portion 63 also extracts image data of the second and third typical distance object images corresponding to the typical distances L₂ and L₃. The typical distances L₁ to L₃ are associated with the first to third typical distance object images, respectively. Then, as illustrated in FIG. 14, the first to third typical distance object images should be displayed together with the slider bar 410 and the distance histogram 430 so that the user can grasp a relationship of the typical distances L₁ to L₃ and the first to third typical distance object images on the distance axis icon 411 or the distance axis 431 of the distance histogram 430. In FIG. 14, the images 441 to 443 are first to third typical distance object images, respectively, and are displayed at positions corresponding to the typical distances L₁ to L₃, respectively.

By displaying the typical distance object image together with the slider bar 410 and the distance histogram 430, the user can viscerally and easily recognizes subjects to be positioned within the depth of field of the target output image and subjects to be positioned outside the depth of field of the target output image. Thus, the depth of field can be set to a desired one more easily.

Note that it is possible to include the slider bar 410 and the typical distance object images in the setting UI and to exclude the distance histogram 430 from the setting UI. Thus, in the same manner as illustrated in FIG. 14, when the adjustment instruction or the confirmation instruction is accepted, each typical distance object image may be displayed in association with the typical distance on the distance axis icon 411.

In addition, a display position of the setting UI is arbitrary. The setting UI may be displayed so as to be superimposed on the target input image 310, or the setting UI and the target input image 310 may be displayed side by side on the display screen. In addition, the longitudinal direction of the distance axis icon 411 and the direction of the distance axis 431 may be other than the horizontal direction of the display screen 51.

A method of calculating the focus reference distance Lo is described below. It is known that the focus reference distance Lo of the noted image obtained by photographing satisfies the following expressions (1) and (2). Here, δ denotes a predetermined permissible circle of confusion of the image sensor 33, f denotes a focal length of the imaging portion 11 when the noted image is photographed, and F is an f-number (in other words, f-stop number) of the imaging portion 11 when the noted image is photographed. Ln and Lf in the expressions (1) and (2) are the near point distance and the far point distance of the noted image, respectively.

δ=(f²·(Lo−Ln))/(F·Lo·Ln) (1)

δ=(f²·(Lf−Lo))/(F·Lo·Lf) (2)

From the expressions (1) and (2), the following expression (3) is obtained.

Lo=2·Ln·Lf/(Ln+Lf) (3)

Therefore, after setting the near point distance Ln and the far point distance Lf of the target output image, the depth of field setting portion 62 can determine the focus reference distance Lo of the target output image by substituting the set distances Ln and Lf into the expression (3). Note that after setting the near point distance Ln and the far point distance Lf of the target output image, the depth of field setting portion 62 may simply sets the distance ((Ln+Lf)/2) to the focus reference distance Lo of the target output image.

### Example 2

Example 2 of the present invention is described below. Example 2 describes another specific method of the adjustment instruction that can be performed in Step S15 of FIG. 9. The image displayed on the display screen 51 when the adjustment instruction is performed in Step S15 is the target input image 310 itself or an image based on the target input image 310. Here, for simple description, it is supposed that the target input image 310 itself is displayed when the adjustment instruction is performed in Step S15 (the same is true for Example 3 that will be described later).

The adjustment instruction in Example 2 is realized by designation operation of designating a plurality of specific objects on the display screen 51, and the user can perform the designation operation as one type of the touch panel operation. The depth of field setting portion 62 generates the depth setting information so that the plurality of specific objects designated by the designation operation are included within the depth of field of the target output image. More specifically, the depth of field setting portion 62 extracts the subject distances of the designated specific objects from the distance map of the target input image 310, and sets the distances of both ends (namely, the near point distance Ln and the far point distance Lf) in the depth of field of the target output image based on the extracted subject distances so that all extracted subject distances are included within the depth of field of the target output image. Further, in the same manner as Example 1, the depth of field setting portion 62 sets the focus reference distance Lo based on the near point distance Ln and the far point distance Lf. The set content is reflected on the depth setting information.

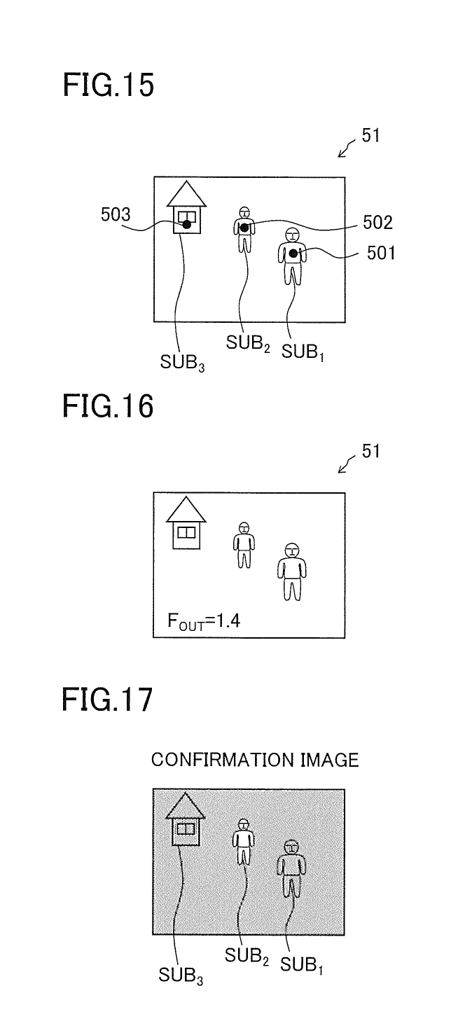

Specifically, for example, the user can designates the subjects SUB₁ and SUB₂ as the plurality of specific objects by touching a display position 501 of the subject SUB₁ and a display position 502 of the subject SUB₂ on the display screen 51 with a finger (see FIG. 15). The touch panel operation of touching a plurality of display positions with a finger may be performed simultaneously or may not be performed simultaneously.

When the subjects SUB₁ and SUB₂ are designated as a plurality of specific objects, subject distances of the pixel positions corresponding to the display positions 501 and 502, namely the subject distances L₁ and L₂ of the subjects SUB₁ and SUB₂ are extracted from the distance map, and the near point distance Ln and the far point distance Lf are set and the focus reference distance Lo is calculated so that the extracted subject distances L₁ and L₂ belong to the depth of field of the target output image. Because L₁<L₂ is satisfied, the subject distances L₁ and L₂ can be set to the near point distance Ln and the far point distance Lf, respectively. Thus, the subjects SUB₁ and SUB₂ are included within the depth of field of the target output image. Alternatively, distances (L₁−ΔLn) and (L₂+ΔLf) may be set to the near point distance Ln and the far point distance Lf. Here, ΔLn>0 and ΔLf>0 are satisfied.

If three or more subjects are designated as a plurality of specific objects, it is preferred to set the near point distance Ln based on the minimum distance among the subject distances corresponding to the three or more specific objects, and to set the far point distance Lf based on the maximum distance among subject distances corresponding to the three or more specific objects. For instance, when the user touches a display position 503 of the subject SUB₃ on the display screen 51 in addition to the display positions 501 and 502 by a finger, the subjects SUB₁ to SUB₃ are designated as the plurality of specific objects. When the subjects SUB₁ to SUB₃ are designated as the plurality of specific objects, the subject distances of the pixel positions corresponding to the display positions 501 to 503, namely the subject distances L₁ to L₃ of the subjects SUB₁ to SUB₃ are extracted from the distance map. Among the extracted subject distances L₁ to L₃, the minimum distance is the subject distance L₁ while the maximum distance is the subject distance L₃. Therefore, in this case, the subject distances L₁ and L₃ can be set to the near point distance Ln and the far point distance Lf, respectively. Thus, the subjects SUB₁ to SUB₃ are included within the depth of field of the target output image. Alternatively, distances (L₁−ΔLn) and (L₃+ΔLf) may be set to the near point distance Ln and the far point distance Lf, respectively.

According to Example 2, the depth of field of the target output image can be easily and promptly set so that a desired subject is included within the depth of field.

Note that when the designation operation of designating the plurality of specific objects is accepted, it is possible to display the slider bar 410 (see FIG. 10A), or a combination of the slider bar 410 and the distance histogram 430 (see FIG. 13A or 13B), or a combination of the slider bar 410, the distance histogram 430, and the typical distance object image (see FIG. 14), which are described in Example 1, together with the target input image 310, and to reflect the near point distance Ln and the far point distance Lf set by the designation operation on the positions of the bar icons 412 and 413. Further, the focus reference distance Lo set by the designation operation may be reflected on a position of the bar icon 418 (see FIG. 10E).

In addition, in order to facilitate the user's designation operation, it is possible to determine the typical distance by the method described above in Example 1, and to display the subject positioned at the typical distance in an emphasized manner, when accepting the designation operation of designating the plurality of specific objects. For instance, when the subject distances L₁ to L₃ are set to the first to third typical distances, the subjects SUB₁ to SUB₃ corresponding to the typical distances L₁ to L₃ may be displayed in an emphasized manner on the display screen 51 where the target input image 310 is displayed. The emphasizing display of the subject SUB₁ can be realized by increasing luminance of the subject SUB₁ on the display screen 51 or by enhancing the edge of the subject SUB₁ (the same is true for the subjects SUB₂ and SUB₃).

### Example 3

Example 3 of the present invention is described below. Example 3 described still another specific method of the adjustment instruction that can be performed in Step S15 of FIG. 9.

The adjustment instruction in Example 3 is realized by the designation operation of designating a specific object on the display screen 51, and the user can perform the designation operation as a type of the touch panel operation. The depth of field setting portion 62 generates the depth setting information so that the specific object designated by the designation operation is included within the depth of field of the target output image. In this case, the depth of field setting portion 62 determines the width of the depth of field of the target output image in accordance with a time length TL while the specific object on the display screen 51 is being touched by the finger in the designation operation.

Specifically, for example, in order to obtain a target output image in which the subject SUB₁ is within the depth of field, the user can designate the subject SUB₁ as the specific object by touching the display position 501 of the subject SUB₁ on the display screen 51 by a finger (see FIG. 15). The time length while the finger is touching the display screen 51 at the display position 501 is the length TL.

When the subject SUB₁ is designated as the specific object, the depth of field setting portion 62 extracts the subject distance at the pixel position corresponding to the display position 501, namely the subject distance L₁ of the subject SUB₁ from the distance map, and sets the near point distance Ln, the far point distance Lf, and the focus reference distance Lo in accordance with the time length TL so that the extracted subject distance L₁ belongs to the depth of field of the target output image. The set content is reflected on the depth setting information. Thus, the subject SUB₁ is within the depth of field of the target output image.

The distance difference (Lf−Ln) between the near point distance Ln and the far point distance Lf indicates the width of the depth of field of the target output image. In Example 3, the distance difference (Lf−Ln) is determined in accordance with the time length TL. Specifically, for example, as the time length TL increases from zero, the distance difference (Lf−Ln) should be increased from an initial value larger than zero. In this case, as the time length TL increases from zero, the far point distance Lf is increased, or the near point distance Ln is decreased, or the far point distance Lf is increased while the near point distance Ln is decreased simultaneously. On the contrary, it is possible to decrease the distance difference (Lf−Ln) from a certain initial value to a lower limit value as the time length TL increases from zero. In this case, as the time length TL increases from zero, the far point distance Lf is decreased, or the near point distance Ln is increased, or the far point distance Lf is decreased while the near point distance Ln is increased simultaneously.

If the subject SUB₁ is designated as the specific object, it is possible to set the near point distance Ln and the far point distance Lf so that L₁=(Lf+Ln)/2 is satisfied, and to determine the focus reference distance Lo based on the set distances Ln and Lf. Alternatively, it is possible to bring the focus reference distance Lo to be agreed with the subject distance L₁. However, as long as the subject distance L₁ belongs to the depth of field of the target output image, the subject distance L₁ may be other than (Lf+Ln)/2 and the focus reference distance Lo.

According to Example 3, it is possible to generate the target output image having a desired width of the depth of field in which a desired subject is within the depth of field by an easy and prompt operation.

Note that when the designation operation of designating the specific object is accepted, it is possible to display the slider bar 410 (see FIG. 10A), or a combination of the slider bar 410 and the distance histogram 430 (see FIG. 13A or 13B), or a combination of the slider bar 410, the distance histogram 430, and the typical distance object image (see FIG. 14), which are described in Example 1, together with the target input image 310, and to reflect the near point distance Ln and the far point distance Lf set by the designation operation on the positions of the bar icons 412 and 413. Further, the focus reference distance Lo set by the designation operation may be reflected on a position of the bar icon 418 (see FIG. 10E).

In addition, in order to facilitate the user's designation operation, it is possible to determine the typical distance by the method described above in Example 1, and to display the subject positioned at the typical distance in an emphasized manner by the method similar to Example 2, when accepting the designation operation of designating the specific object.

### Example 4

Example 4 of the present invention is described below. Example 4 and Example 5 that is described later can be performed in combination with Examples 1 to 3. Example 4 describes the confirmation image that can be generated by the confirmation image generating portion 64 illustrated in FIG. 5. As described above, the confirmation image can be an image based on the target input image.

In Example 4, information JJ indicating the depth of field of the target output image defined by the depth setting information is included in the confirmation image. The information JJ is, for example, the f-number corresponding to the depth of field of the target output image. Supposing that the image data of the target output image is obtained not by the digital focus but by only sampling of the optical image on the image sensor 33, an f-number F_{OUT} in photographing the target output image can be determined as the information JJ.

The distances Ln, Lf, and Lo determined by the above-mentioned method are included in the depth setting information, which is sent to the confirmation image generating portion 64. The generating portion 64 substitutes the distances Ln, Lf, and Lo included in the depth setting information into the above expression (1) or (2) so as to calculate the value of F of the expression (1) or (2) and to determine the calculated value as the f-number F_{OUT} in photographing the target output image (namely as information JJ). In this case, a value of the focal length fin the expression (1) or (2) can be determined from a lens design value of the imaging portion 11 and optical zoom magnification in photographing the target input image, and a value of the permissible circle of confusion 5 in the expression (1) or (2) is set in advance. Note that when the value of F in the expression (1) or (2) is calculated, it is necessary to bring the units of the focal length f and the permissible circle of confusion δ to be matched with each other (for example, they should be matched to be a unit after conversion into 35 mm film or a real scale unit).

When the depth setting information is given, the confirmation image generating portion 64 determines the f-number F_{OUT} and can generate the image in which the f-number F_{OUT} is superimposed on the target input image as the confirmation image. The confirmation image illustrated in Example 4 can be generated and displayed in Step S17 of FIG. 9. FIG. 16 illustrates an example of the display screen 51 on which the f-number F_{OUT} is displayed. In the example illustrated in FIG. 16, the f-number F_{OUT} is superimposed and displayed on the target input image, but it is possible to display the target input image and the f-number F_{OUT} side by side. In addition, in the example of FIG. 16, the f-number F_{OUT} is indicated as a numeric value, but the expression method of the f-number F_{OUT} is not limited to this. For instance, the display of the f-number F_{OUT} may be realized by an icon display or the like that can express the f-number F_{OUT}.

In addition, an image in which the f-number F_{OUT} is superimposed on the target output image based on the depth setting information may be generated and displayed as the confirmation image. Instead of superimposing and displaying the f-number F_{OUT} on the target output image, it is possible to display the target output image and the f-number F_{OUT} side by side.

Note that in Step S19 of FIG. 9 or other step, when the target output image is recorded in the recording medium 16, the information JJ can be stored in the image file of the target output image so as to conform a file format such as the Exchangeable image file format (Exif).

Because the f-number F_{OUT} is displayed, the user can grasp a state of the depth of field of the target output image in relationship with normal photography conditions of the camera, and can easily decide whether or not the depth of field of the target output image is set to a desired depth of field. In other words, the setting of the depth of field of the target output image is assisted.

### Example 5

Example 5 of the present invention is described below. Example 5 describes another example of the confirmation image that can be generated by the confirmation image generating portion 64 of FIG. 5.

In Example 5, when the depth setting information supplied to the confirmation image generating portion 64, the confirmation image generating portion 64 classifies pixels of the target input image into pixels outside the depth corresponding to the subject distance outside the depth of field of the target output image and pixels within the depth corresponding to the subject distance within depth of field of the target output image by the above-mentioned method using the distance map and the depth setting information. In the same method, pixels of the target output image can also be classified into the pixels outside the depth and the pixels within the depth. An image region including all pixels outside the depth is referred to as a region outside the depth, and an image region including all pixels within the depth is referred to as a region within the depth. The pixels outside the depth and the region outside the depth correspond to the blurring target pixels and the blurring target region in the digital focus. The pixels within the depth and the region within the depth correspond to the non-blurring target pixels and the non-blurring target region in the digital focus.

The confirmation image generating portion 64 can perform image processing IP_{A} for changing luminance, hue, or chroma saturation of the image in the region outside the depth, or image processing IP_{B} for changing luminance, hue, or chroma saturation of the image in the region within the depth, on the target input image. Then, the target input image after the image processing IP_{A}, the target input image after the image processing IP_{B}, or the target input image after the image processings IP_{A} and IP_{B} can be generated as the confirmation image. FIG. 17 illustrates an example of the confirmation image based on the target input image 310 of FIG. 6A. In the depth setting information when the confirmation image of FIG. 17 is generated, it is supposed that only the subject SUB₂ is within the depth of field while the subjects SUB₁ and SUB₃ are positioned outside the depth of field. The image having decreased luminance or chroma saturation of the image in the region outside the depth of the target input image is the confirmation image of FIG. 17. It is possible to perform a process of further enhancing the edge of the image in the region within the depth on the image having decreased luminance or chroma saturation of the image in the region outside the depth of the target input image, and to generate the image after the process as the confirmation image.

The confirmation image of Example 5 can be generated and displayed in Step S17 of FIG. 9. Thus, whenever the depth setting information is changed by the adjustment instruction, it is possible to display how the change content is reflected on the image in real time so that the user can easily confirm a result of the adjustment instruction. For instance, if Examples 1 and 5 are combined, whenever the position of the slider bar 412 or 413 is changed by the adjustment instruction (see FIG. 11), the confirmation image on the display screen 51 is also changed in accordance with the changed position.

Note that the confirmation image generating portion 64 can generate the confirmation image based on the target output image instead of the target input image. In other words, it is possible to perform at least one of the above-mentioned image processings IP_{A} and IP_{B} on the target output image, so as to generate the target output image after the image processing IP_{A}, the target output image after the image processing IP_{B}, or the target output image after the image processings IP_{A} and IP_{B}, as the confirmation image.

### Example 6

Example 6 of the present invention is described below. The method of using so-called pan-focus for obtaining the target input image as the pan-focus image is described above, but the method of obtaining the target input image is not limited to this.

For instance, it is possible to constitute the imaging portion 11 so that the RAW data contains information indicating the subject distance, and to construct the target input image as the pan-focus image from the RAW data. In order to realize this, the above-mentioned Light Field method can be used. According to the Light Field method, the output signal of the image sensor 33 contains information of the incident light propagation direction to the image sensor 33 in addition to the light intensity distribution in the light receiving surface of the image sensor 33. It is possible to constitute the target input image as the pan-focus image from the RAW data containing this information. Note that when the Light Field method is used, the digital focus portion 65 generates the target output image by the Light Field method. Therefore, the target input image based on the RAW data may not be the pan-focus image. It is because that when the Light Field method is used, the target output image having an arbitrary depth of field can be freely constituted after the RAW data is obtained, even if the pan-focus image does not exist.

In addition, it is possible to generate the ideal or pseudo pan-focus image as the target input image from the RAW data using a method that is not classified into the Light Field method (for example, the method described in JP-A-2007-181193). For instance, it is possible to generate the target input image as the pan-focus image using a phase plate (or a wavefront coding optical element), or to generate the target input image as the pan-focus image using an image restoration process of eliminating blur of an image on the image sensor 33.

<<Variations>>

The embodiment of the present invention can be modified variously as necessary within the scope of the technical concept described in the claims. The embodiment is merely an example of the embodiment of the present invention, and meanings of the present invention and terms of elements are not limited to those described in the above-mentioned embodiment. The specific numeric values mentioned in the above description are merely examples and can be changed to various numeric values as a matter of course. As annotations that can be applied to the above-mentioned embodiment, Notes 1 to 4 are described below. The descriptions in the Notes can be combined freely as long as no contradiction arises.

[Note 1]

There is described the method of setting the blurring amount for every subject distance to zero as the initial setting in Step S13 of FIG. 9, the method of the initial setting is not limited to this. For instance, in Step S13, one or more typical distances may be set from the distance map in accordance with the above-mentioned method, and the depth setting information may be set so that the depth of field of the target output image becomes as shallow as possible while satisfying the condition that the individual typical distances belong to the depth of field of the target output image. In addition, it is possible to apply known scene decision to the target input image and to set the initial value of the depth of field using a result of the scene decision. For instance, the initial setting of Step S13 may be performed so that the depth of field of the target output image before the adjustment instruction becomes relatively deep if the target input image is decided to be a scene in which a landscape is photographed, and so that the depth of field of the target output image before the adjustment instruction becomes relatively shallow if the target input image is decided to be a scene in which a person is photographed.

[Note 2]

The individual portions illustrated in FIG. 5 may be disposed in the electronic equipment (not shown) other than the image pickup apparatus 1, and the actions described above may be realized in the electronic equipment. The electronic equipment is, for example, a personal computer, a mobile information terminal, or a mobile phone. Note that the image pickup apparatus 1 is also one type of the electronic equipment.

[Note 3]

In the embodiment described above, actions of the image pickup apparatus 1 are mainly described. Therefore, an object in the image or on the display screen is mainly referred to as a subject. It can be said that a subject in the image or on the display screen has the same meaning as an object in the image or on the display screen.

[Note 4]

The image pickup apparatus 1 of FIG. 1 and the above-mentioned electronic equipment can be constituted of hardware or a combination of hardware and software. When the image pickup apparatus 1 and the electronic equipment are constituted using software, a block diagram of a portion realized by software expresses a function block diagram of the portion. In particular, the entire or some of functions realized by the individual portions illustrated in FIG. 5 (except the monitor 15) may be described as a program, and the program may be executed by a program execution device (such as a computer) so that the entire or some of the functions are realized.

What is claimed is:

1. An electronic equipment comprising:
a target output image generating portion that generates a target output image by changing a depth of field of a target input image by image processing;
a monitor that displays on a display screen a distance histogram indicating a distribution of distance between an object at each position in the target input image and an apparatus that photographed the target input image, and displays on the display screen a selection index that is movable along a distance axis in the distance histogram; and
a depth of field setting portion that sets a depth of field of the target output image based on a position of the selection index determined by an operation for moving the selection index along the distance axis.

2. The electronic equipment according to claim 1, wherein the depth of field setting portion sets the depth of field of the target output image so that a distance on the distance axis corresponding to the position of the selection index belongs to the depth of field of the target output image.

3. The electronic equipment according to claim 1, wherein the depth of field setting portion sets a typical distance from frequencies of the distance histogram and extracts image data of an object corresponding to the typical distance from the image data of the target input image, and hence a typical distance object image based on the extracted image data is displayed on the display screen in association with the typical distance of the distance histogram.

4. An electronic equipment comprising:
a target output image generating portion that generates a target output image by changing a depth of field of a target input image by image processing;
a touch panel monitor having a display screen that accepts a touch panel operation when a touching object touches the display screen, and accepts a designation operation as the touch panel operation for designating a plurality of specific objects on the display screen in a state where the target input image or an image based on the target input image is displayed on the display screen; and
a depth of field setting portion that sets a depth of field of the target output image based on the designation operation.

5. The electronic equipment according to claim 4, wherein the depth of field setting portion sets the depth of field of the target output image so that the plurality of specific objects are included within the depth of field of the target output image.

6. The electronic equipment according to claim 4, wherein the depth of field setting portion extracts a distance between each specific object and an apparatus that photographed the target input image from a distance map indicating a distance between and object at each position on the target input image and the apparatus, and sets distances at both ends of the depth of field of the target output image based on the extracted distance.

7. An electronic equipment comprising:
a target output image generating portion that generates a target output image by changing a depth of field of a target input image by image processing;
a touch panel monitor having a display screen that accepts a touch panel operation when a touching object touches the display screen, and accepts a designation operation as the touch panel operation for designating a specific object on the display screen in a state where the target input image or an image based on the target input image is displayed on the display screen; and
a depth of field setting portion that sets a depth of field of the target output image so that the specific object is included in the depth of field of the target output image, wherein
the depth of field setting portion sets a width of the depth of field of the target output image in accordance with a time length while the touching object is touching the specific object on the display screen in the designation operation.

8. An electronic equipment comprising:
a target output image generating portion that generates a target output image by changing a depth of field of a target input image by image processing;
a depth of field setting portion that sets a depth of field of the target output image in accordance with a given operation; and
a monitor that displays information indicating the set depth of field.

9. The electronic equipment according to claim 8, wherein the information contains an f-number corresponding to the set depth of field.
